(19) United States
(12) Patent Application Publication
(10) Pub. No.: US 2018/0218390 A1
(43) Pub. Date: Aug. 2, 2018

(54) A MEDIA MANAGEMENT SYSTEM AND METHOD DETERMINING AND BROADCASTING COMMERCIAL FILMS FOR ALL MARKETABLE PRODUCTS ACCORDING TO CONSUMER PREFERENCES

(71) Applicant: Özgür BULDUM, Istanbul (TR)

(72) Inventor: Özgür BULDUM, Istanbul (TR)

(21) Appl. No.: 15/747,602

(22) PCT Filed: Nov. 26, 2015
(86) PCT No.: PCT/TR2015/050199

§ 371 Date: Jan. 25, 2018

(30) Foreign Application Priority Data
Jul. 30, 2015 (TR) 2015/09471

(51) Int. Cl. G06Q 30/02; G06F 17/30

(52) U.S. Cl. CPC G06Q 30/0242; G06Q 30/0267; G06Q 30/0255; G06F 17/30876

(57) ABSTRACT

The present invention relates to a system transforming mobile communication service providers into media outlets/audio-visual media organs broadcasting commercial films for all marketable products in all of the smart devices of their subscribers that have internet connection and audio-visual broadcasting abilities, and associating these smart devices with each other.

### TECHNICAL FIELD

The invention relates to a system and a method transforming mobile communication service providers into media outlets/audio-visual media organs broadcasting commercial films for all marketable products in all of the smart devices of their subscribers that have internet connection and audio-visual broadcasting abilities, and associating these smart devices with each other.

### THE PRIOR ART

Advertisement/Commercial means promotion of various goods, products, and services to target groups and consumers for a certain fee through television, newspaper, radio, billboard, magazine, cinema, and internet etc. media. The main components of this work are:
the advertisement should be produced for a fee, the advertisers should be definite, during promotion of goods, products, or services, visual, auditory and written media tools appealing to wide target groups and consumers should be used.

An advertisement informs consumers in various ways about goods, products, and services and their uses such as where, how, and at what price they can be purchased, and guides consumers for buying the right goods and products. It is a significant auxiliary factor for enterprises in increasing their market shares and increasing their brand values, determining new production policies, and guiding investments.

Companies tend towards mobile advertising that has developed as an alternative to prior art advertisement methods together with the developing technology. Mobile advertising is more economical compared to television advertising and as it may provide presentation of advertisements for determined target groups it is evaluated as more advantageous. However, nowadays, in various mobile advertisement applications, a relation cannot be established between users and the advertisements/commercials presented to them, and advertisements are shown with ordinary methods. Therefore, most of the advertisements are irrelevant to the demands or areas of interest of users, and the desired results cannot be achieved since they do not attract the users' attention.

While these mobile advertisements provided to users out of their areas of interests do not make any contribution for the users, people may also be annoyed by these advertisements that appear while using their devices. On the other hand, advertisers cannot make adequate advertising and relevant sales, since their commercials cannot be presented to relevant people in an effective manner. As a result of these, presentation of advertisements intended for the target group, which is the main purpose of mobile advertising, cannot be achieved.

In the known status of the art, a system processing data in the same way and producing same results does not exist. In the prior art, mobile games rarely play commercial films (mostly commercial films of animation games), and generally provide links to websites such as YouTube where commercial films can be played.

Technically, mobile communication service providers are not able to broadcast commercial films directly, they are only able to make announcements to their subscribers via short message (SMS) and e-mail, mostly about their own campaigns. When mobile communication service providers share the information of a certain number of subscribers with advertisers, then the advertisers provide product/campaign promotions to the subscribers by sending short messages (SMS) and/or e-mails. However, following various countries agreeing in that this situation is quite annoying for consumers, with the “Law on Regulation of Electronic Commerce”, on May 1, 2015, Turkey has also concluded that no short messages (SMS) or e-mails can be sent to consumers without their consent. Similar laws starting to take effect all around the world prove the significance of this problem.

As can be seen in FIG. 4, especially free versions of mobile phone and tablet games, instead of broadcasting commercial films, provide advertisement links or download links entering the screen from one of its four sides.

The free versions of mobile games that broadcast commercial films usually broadcast commercial films of games and mobile applications instead of commercial films of everything marketable.

As can be seen in FIG. 5, a button for closing the commercial film exists on the top right corner, which enables skipping the commercial film without watching it and thus avoiding disturbance. In other similar applications, in order not to prolong users' disturbance, after how many seconds the commercial film may be skipped without watching is stated on the top left corner and after how many seconds the commercial film will end if it is watched entirely is stated on the bottom right corner.

The producers, knowing that the users also find these kinds of commercials annoying, provide ad-free versions of games to the users, provided that they purchase the paid games. It is clearly stated in relevant user agreements that the free versions of mobile games include third party advertisements, and these kinds of notifications and advertisements are not found in some paid versions.

In the prior art situation, these advertisement applications, most of which do not present commercial films, appear as a burden for the users, which they want to get rid of by paying, as can be seen in the paid or free mobile game example. The fundamental problems causing this are:
serving advertisements to the users without analyzing their consumer profiles adequately and therefore presenting advertisements out of their areas of interests,
the users not having initiative about when the advertisement applications would be displayed,
seeing or reading advertisement posters or watching commercial films not providing any financial gain for the users.

There are some activities with the purpose of providing advertisements to potential customers who might be interested in the presented products. However, these applications are only limited to social media sites (such as Facebook), which access the information of users' navigation on the internet and provide website links on the right hand side of user main pages where they can click and go to the link and examine the product if they wish. The problem in these kinds of activities is that the user needs to spend his/her own time and effort in order to reach the promotion and page of the relevant product.

Video sharing websites, as a media where commercial films can be broadcasted on the internet (such as YouTube), insert the commercial films of advertisers at the beginning of videos with high number of views. Since these commercial films also cause an annoying situation for users, an option of skipping without watching is provided at the 4th second of the films. (FIG. 6)

In our country, the media where commercial films are most commonly broadcasted is television. When television is used as the media for broadcasting commercial films, the problem to be solved is not being able to rate the areas of interest of people who watch the films.

The commercial films are broadcasted prior to, during or at the end of TV programmes. In order to present commercial films to the highest possible number of viewers; the rating values of these TV programmes are evaluated. Even though these evaluations are made, it is a problem that the potential customer cannot be targeted efficiently. It is quite possible that a makeup material commercial film can be presented to a male consumer, while a razor blade commercial film can be presented to a female consumer. Another problem encountered in this medium is the television media having very high costs based on the per second broadcast of commercial films. Since there is no other alternative media that is more efficient than television, advertisers have to use television media even though its investment return rates of advertisement are low.

Another problem aimed to be solved with the present invention is the high tariff costs reflected to subscribers of mobile communication service providers, since the mobile communication services are already expensive.

A patent application with No. TR201214618 was encountered in another prior art research. In this application, a mobile advertising display system is explained, comprising a screen on which mobile advertisements served to a user is displayed and an electronic device which can provide internet connection, when required. It is disclosed that the mobile advertisement display system comprises a server which determines and transmits the advertisement to the user's device regarding the data received from at least one of the sensors, provided on the electronic device, which detects environmental factors such as sound, temperature, images in the surroundings where the electronic device exists.” In order to ensure the display of said advertisement disclosed in this application, both the server and the user are required to be found in the same environment (for instance in the same shopping mall).

A patent application with No. TR200800895 was encountered in another prior art research. In this application, a mobile advertisement method is disclosed, which adds an advertisement to a part of a mobile phone message, and which determines relevant advertisements by evaluating a user profile, user location, message content, the sending time of the message, previous advertisements submitted to the user, and shopping transactions made by the user. Moreover, in this method, the user can make use of a free or cut-price message service, and feedback calculations can be made as a result of advertisements.

A patent application with No. TR201207688 was encountered in another prior art research. In this application, a system is disclosed, which makes taking orders easier in restaurants, cafeterias etc. indoor places and at the same time visually presents advertisement applications, and it is also mentioned that the system transmits the order taken from a tablet computer to servers, and while the data is kept on the server, it is also displayed on other tablet computers or screens in the kitchen and the payment point.

A utility model application with No. TR199902142 was encountered in another prior art research. In this application, as a solution to the problem of advertisements not being viewed at desired levels since TV viewers turn over (zapping) a TV channel when commercials start to play, a system is disclosed, which is formed of an electronic device and a computer software, which monitors a viewer to ensure that the viewer watches TV commercials entirely, reports the results, and motivates the viewers by an income or prize in proportion to the total amount of time period that he/she watches commercials, and which increases the rating and the advertisement revenues of the TV channels that use this system.

As a result, the above said drawbacks and the inadequacy of the prior art solutions about the subject have necessitated an improvement in the related technical field.

### Purpose of the Invention

The purpose of the invention is to transform mobile communication service provider into a media outlet/media organ broadcasting commercial films of all marketable products on smart devices with media management module, which is a part of its system.

The purpose of the invention is to provide controlled advertisement sharing by getting consent of subscribers about watching commercial films daily, in a number determined by the mobile communication service provider.

The purpose of the invention is to provide more informed advertisement sharing by accessing the information indicated by the subscribers about their areas of interests, their shopping habits, and the brands and product groups whose commercial films they would like to watch.

The purpose of the invention is to form a potential customer database on a server by means of adding the subscriber shopping habits information and customized settings information obtained from the subscriber via the media management module, to the demographic subscriber information provided by the mobile communication service provider, and then transmitting all of the information to the server.

The purpose of the invention is to reduce the error margin of consumer analysis results, which is assumed to be at minimum, to values close to zero as the system is kept being used, since the potential customer database will be updated with the new information provided by the media management module in certain intervals.

The purpose of the invention is to provide the media management module to operate and directly play the commercial film determined by the server. For this to be possible, when the media management module is operated for the first time in subscribers' smart devices, the subscribers take the initiative and report the other modules they use in their free times to authorize the media management module to operate just before them.

As a purpose of the invention, the problem of disturbance caused by advertisement applications for the users will be solved, because when the media management module is operated for the first time, the subscribers take the initiative and determine the other modules before which the media management module would operate on their devices.

Another purpose of the invention is to prevent the subscribers from wasting effort and time in order to access the product promotion/product page, since the media management module directly plays the commercial films.

The purpose of the invention is to enable determination of whether the commercial film is watched or not by means of the face recognition system of the media management module on smart devices with front cameras, and let the media management module transmit this situation as data to the potential customer database within the concept of information received from the subscribers.

The purpose of the invention is to make the media management module, which broadcasts commercial films, an alternative advertisement medium with higher advertisement investment return rates than television, since it will broadcast potential customer database-supported commercial films and it can be used in smart devices having front cameras to ensure that the commercial film is watched entirely by the users.

The purpose of the invention is to transform mobile communication service providers into media outlets/media organs broadcasting commercial films and thus provide reduction of the tariff costs of the subscribers due to the income obtained. In this regard, the subscribers can benefit from tariff discounts and/or advantageous campaigns in direct proportion to the total number of commercial films they watch daily.

The purpose of the invention is to provide people, who cannot benefit from mobile communication services due to their income levels, as new subscribers to the mobile communication service providers and potential customers for the advertisers due to the low subscriber tariffs.

Another purpose of the invention is to change the situation of subscribers from being victims who are targeted, pursued, exposed to unwanted advertisements, and whose time and effort are stolen, into being a part of a system which is beneficial to all parties including themselves.

The invention is formed with the inspiration from the prior art situations and aims to solve the above said problems.

The structural and characteristic features of the invention and all of its advantages shall be understood better with the figures and the detailed description given below in reference to the figures, and therefore, the assessment should be made by taking into account the said figures and detailed explanations.

### FIGURES FOR BETTER UNDERSTANDING OF THE INVENTION

FIG. 1—is the schematic block diagram of the media management system.

FIG. 2—is the schematic block diagram of the media management method.

FIG. 3—is the schematic block diagram of the multi-media management system.

FIG. 4—is a video commercial illustration comprising a link.

FIG. 5—is a video commercial illustration which has the option of closing the window.

FIG. 6—is a video commercial illustration which has the option of skipping the commercial film.

### DESCRIPTION OF REFERENCES

1. Media management system
10. Advertiser
20. Mobile communication service provider
   21. Subscriber demographic information
30. Server
40. Potential customer database
50. Commercial films storage space
60. Smart device
   61. Front camera
   62. Media management module
   63. Other modules
70. Subscriber shopping habits information
80. Customized settings information
1000. Media management method
1001. Entering the identity and demographic information of existing subscribers that are already held by the mobile communication service provider into a potential customer database operating on a server,
1002. Operating the media management module on the smart devices of the subscribers,
1003. The subscribers saving their subscriber shopping habits information and customized settings information into the media management module,
1004. Transmission of the received subscriber shopping habits information and customized settings information to the server via the media management module in order to be entered into the potential customer database,
1005. The server processing the potential customer database with the previously existing information and the newly entered information and transmitting the reports to the mobile communication service provider,
1006. The mobile communication service provider transmitting these reports to the advertiser exactly as they are or after filtering them,
1007. The advertiser analyzing the reports provided by the mobile communication service provider and transmitting to the mobile communication service provider a commercial film in a suitable format together with the information of the subscribers on whose smart devices the advertiser requires this commercial film to be broadcasted,
1008. The mobile communication service provider transmitting to the server a commercial film in a suitable format together with the information of the subscribers on whose smart devices the advertiser requires this commercial film to be broadcasted,
1009. The server placing the commercial film into the commercial films storage space, and sharing the information on the new commercial film with the media management module on the smart devices of the selected subscribers,
1010. The media management module operating and playing the commercial film transmitted from the server, just before the other modules that the subscriber wishes to operate in his/her device in his/her free time
1011. The media management module determining whether the subscriber (A) has watched the commercial film or not via the face recognition system on smart devices with front cameras
1012. The media management module reporting whether the subscriber (A) has watched the commercial film or not, to the potential customer database on the server

A: Subscriber (User)

Drawings do not have to be scaled and details not necessary for understanding the present invention may be neglected. Moreover, components which are at least widely equal or which have at least widely equal functions are shown with the same number.

### DETAILED DESCRIPTION OF THE INVENTION

In this detailed description, the preferred embodiments of the system according to the present invention, will only be disclosed for better understanding of the subject.

The media management system (1) according to the invention and its components and characteristics are given below:

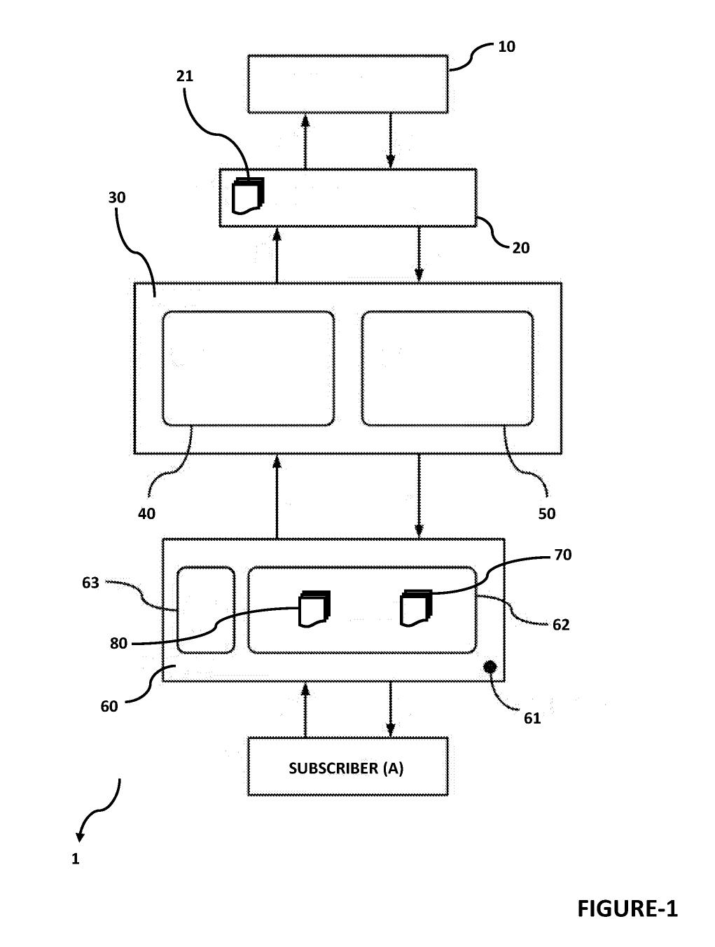

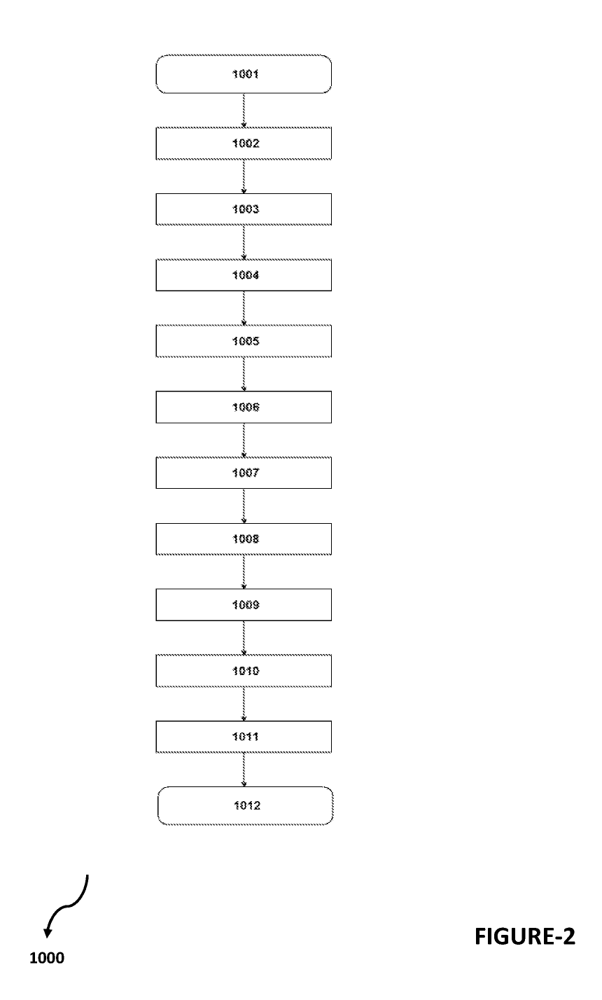

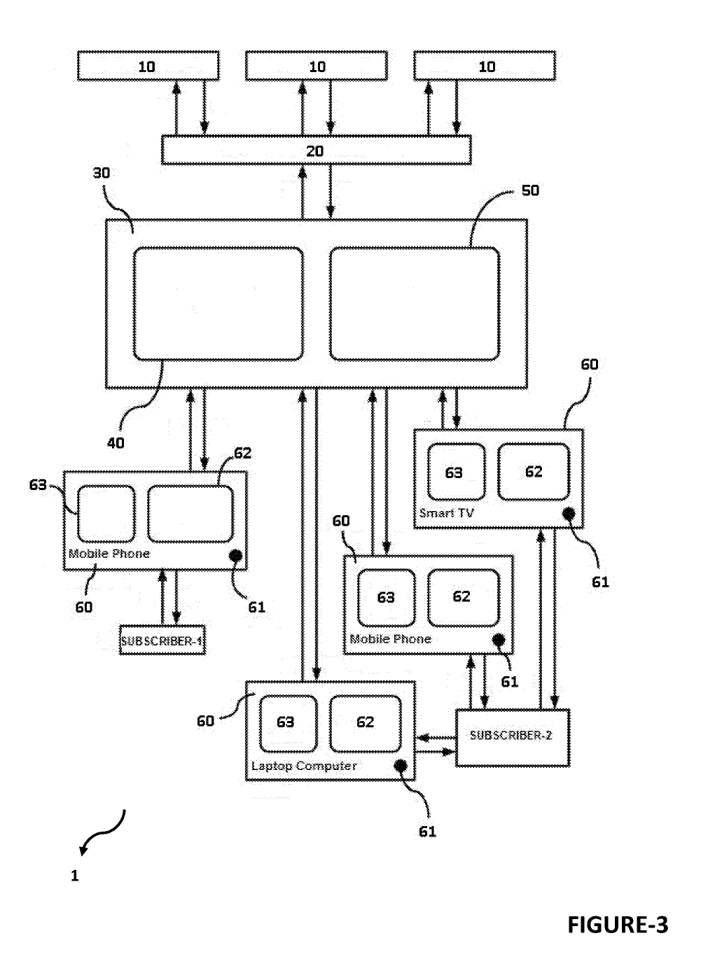

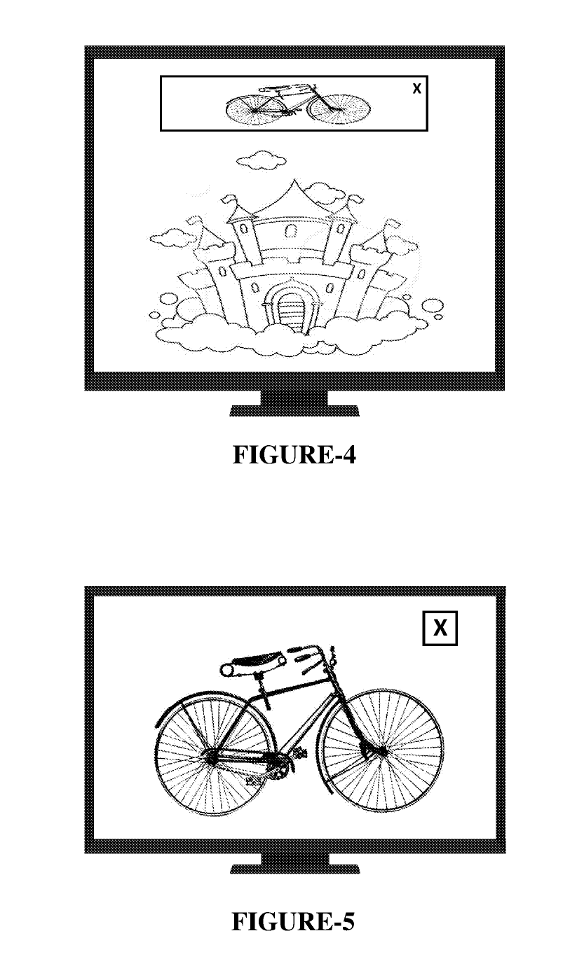

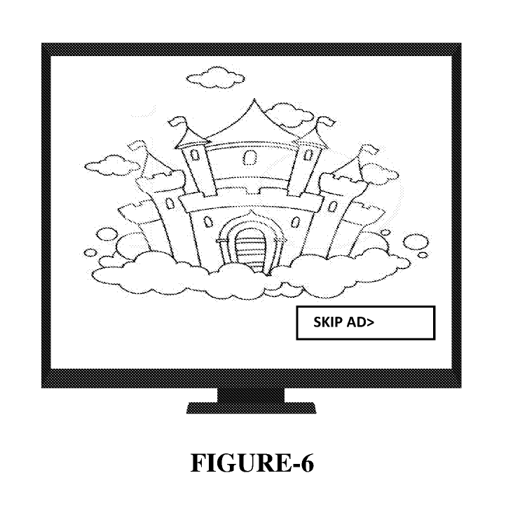

In FIG. 1, the units forming the media management system (1) is shown as a schematic block diagram. The system (1) comprises the units of: Advertiser (10), mobile communication service provider (20), subscriber demographic information (21), subscriber shopping habits information (70), customized settings information (80), server (30), potential customer database (40), commercial films storage space (50), smart device (60), front camera (61), media management module (62), and other modules (63).

Advertiser (10): It is the unit that transmits to the mobile communication service provider (20) the commercial films and the information of the subscribers (A) on whose smart devices (60) these commercial films are to be broadcasted.

Mobile communication service provider (20): It is the unit which provides mobile internet service when the system (1) requires in order to operate, shares the subscriber demographic information (21) with the potential customer database (40) on the server (30), transmits the commercial films to the server (30) to be loaded to the commercial films storage space (50), transmits to the server (30) the information of the subscribers (A) on whose smart devices (60) the advertiser (10) requires the commercial films to be broadcasted, and presents the reports it has received from the potential customer database (40) to the advertiser (10) as they are or after filtering them.

Subscriber demographic information (21): It represents the demographic information such as the identity and gender, race, age, employment state, level of income, occupation, residence etc. of the subscribers (A) of the mobile communication service provider (20).

Subscriber shopping habits information (70): It represents the information which the subscribers (A) enter into the media management module (62), such as their areas of interests, shopping habits, on which websites they search for products and/or from which websites they purchase products, and which products′/brands' commercial they would like to watch on the media management module (62) etc.

Customized settings information (80): It represents the information concerning;
before which other modules (63) installed on their smart devices (60), the subscribers (A) would like the media management module (62) to operate,
which of their smart devices (60) they choose to associate with the media management module (62),
the frequency of updating the information (70, 80) that the media management module (62) would obtain from the subscriber (A),
the synchronization of the media management module (62) with the search engines and web browsers,

Server (30): It is the unit:
comprising the potential customer database (40) and commercial films storage space (50),
processing and updating the potential customer database (40) with the subscriber shopping habits information (70) and customized settings information (80) provided by the media management module (62), and the subscriber demographic information (21) provided by the mobile communication service provider (20), and reporting to the mobile communication service provider (20),
transmitting the commercial films from the commercial films storage space (50) to the media management modules (62) on the smart devices (60) of the subscribers (A), which are selected from the potential customer database (40) in accordance with the preferences of the advertiser (10) provided by the mobile communication service provider (20).

Potential customer database (40): It is the unit that gathers the subscriber demographic information (21) provided by the mobile communication service provider (20) and the subscriber shopping habits information (70) and customized settings information (80) provided by the media management module (62).

Commercial films storage space (50): It is the unit that stores the commercial films transmitted from the mobile communication service provider (20).

Smart device (60): It is the platform of operation of the media management module (62) and other modules (63), and it is the unit that represents all devices that have internet connection and audio-visual film broadcasting abilities.

Front camera (61): It is the unit which exists on the front side of smart devices (60) and is used for determining the interest of subscribers (A) concerning the commercials.

Media management module (62): It is the unit which;
plays the commercial films transmitted from the server (30) just before operation of the other modules (63) that the subscribers (A) would like to operate,
transmits to the potential customer database (40), the subscriber shopping habits information (70) and customized settings information (80) obtained from the subscribers (A),
associates all of the available smart devices (60) indicated by the subscribers (A) with each other, and thus enables the subscribers (A) to meet their daily commercial film quota, determined by the mobile communication service provider (20), by watching the required commercial films on various smart devices (60).

Also, it is the unit that can determine whether a subscriber (A) watches the commercial film entirely or not, by operating the front camera (61) when the film starts to play.”

Other modules (63): They represent the other modules that already exist on the subscriber's (A) smart device (60), before which the media management module (62) plays commercial films, as the subscriber (A) has selected these modules to be the ones he/she uses in his/her free time when the media management module (62) was operated for the first time in his/her smart device (60).

A media management system (1) transforming mobile communication service providers (20 into media outlets/audio-visual media organs broadcasting commercial films for all marketable products in all smart devices (60) of their subscribers (A) that have internet connection and audio-visual broadcasting abilities, and associating these smart devices (60) with each other, comprising:
At least one advertiser (10) transmitting to the mobile communication service provider (20) the commercial films and the information of the subscribers (A) on whose smart devices (60) these commercial films are required to be broadcasted,
At least one mobile communication service provider (20) which provides mobile internet service, shares the subscriber demographic information (21) with the potential customer database (40) on the server (30), transmits the commercial films to the server (30) to be loaded into the commercial films storage space (50), transmits to the server (30) the information of the subscribers (A) on whose smart devices (60) the advertiser (10) requires the commercial films to be broadcasted, and presents the reports it has received from the potential customer database (40) to the advertiser (10) exactly as they are or after filtering them,
At least one subscriber demographic information (21) representing the information such as identity and gender, race, age, employment state, level of income, occupation, residence etc. of the subscribers (A) of mobile communication service provider (20),
At least one subscribers shopping habits information (70) which the subscribers enter into the media management module (62) such as their areas of interests, shopping habits, on which websites they search for products and/or from which websites they purchase products, and which products′/brands' commercials they would like to watch on the media management module (62) etc.
At least one customized setting information (80) concerning:
   before which other modules (63) installed on their smart devices (60), the subscribers (A) would like the media management module (62) to operate,
   which of their smart devices (60) they choose to associate with the media management module (62),
   the frequency of updating the information (70, 80) that the media management module (62) would obtain from the subscriber (A),
   the information about the synchronization of the media management module (62) with the search engines and web browsers,
At least one server (30):
   processing and updating the potential customer database (40) with the subscriber shopping habits information (70) and customized settings information (80) provided by the media management module (62) and the subscriber demographic information (21) provided by the mobile communication service provider (20), and reporting to the mobile communication service provider (20),
   transmitting the commercial films from the commercial films storage space (50) to the media management modules (62) on the smart devices (60) of the subscribers (A) selected from the potential customer database (40) in accordance with the preferences of the advertiser (10) which are received from the mobile communication service provider (20),
   At least one potential customer database (40) that gathers, processes, and reports, the subscriber demographic information (21) provided by the mobile communication service provider (20) and the subscriber shopping habits information (70) and customized settings information (80) provided by the media management module (62),
At least one commercial films storage space (50) that stores the commercial films transmitted from the mobile communication service provider (20),
At least one smart device (60) that operates the media management module (62) and has internet connection and audio-visual film broadcasting abilities,
At least one front camera (61) which exists on the front side of smart devices (60) and is used for determining the interest of subscribers (A) concerning the commercials,
At least one media management module (62) which:
   plays the commercial films transmitted from the server (30) just before the operation of the other modules (63) that the subscribers (A) would like to operate,
   transmits to the potential customer database (40), the subscriber shopping habits information (70) and customized settings information (80) obtained from the subscribers (A),
   associates all of the available smart devices (60) indicated by the subscribers (A) with each other, and thus enables the subscribers to meet their daily commercial film quota, determined by the mobile communication service provider (20), by watching the required commercial films on various smart devices (60),
   is able to determine whether the subscribers (A) watch commercial films entirely or not, by activating the front camera (61) when the film starts to play,
At least one other module (63), installed on the smart device (60), which is independent from the media management module (62) and before which the media management module (62) operates.

The system (1) starts to operate by first entering the identity and subscriber demographic information (21) of existing subscribers (A), which are already held by the mobile communication service provider (20), into the potential customer database (40) operating on the server (30). When the media management module (62) is installed and operated for the first time in the desired number of smart devices (60) with audio-visual broadcasting abilities, the media management module will be able to obtain:
a) Subscriber shopping habits information (70) such as:
   subscribers' (A) areas of interests, shopping habits,
   on which websites the subscribers (A) search for products, from which websites they purchase products,
   which products' and brands' commercial films they want to watch etc.
b) Customized settings information (80) such as:
   before which other modules (63) installed on their smart devices (60), the subscribers would like the media management module (62) to operate,
   which of their smart devices (60) they choose to associate with the media management module (62),
   what kind of searches they make on search engines and which of these searches they prefer the media management module (62) to report,
   and the frequency of updating the information (70, 80) that the media management module (62) would obtain from the subscriber (A) etc.

When the media management module (62) operates, the subscriber shopping habits information (70) and customized settings information (80) received from the subscriber (A) will be transmitted to the server (30) via the media management module (62) in order to be entered into the potential customer database (40). The server (30) will process the potential customer database (40) with the previously existing information (21) and the newly entered information (70, 80) and transmit the reports to the mobile communication service provider (20). The mobile communication service provider (20) will transmit these reports to the advertiser (10) exactly as they are or after filtering them. The advertiser (10) will analyze the reports provided by the mobile communication service provider (20) and transmit to the mobile communication service provider (20) a commercial film in a suitable format together with the information of the subscribers (A) on whose smart devices (60) the advertiser requires this commercial film to be broadcasted.

The mobile communication service provider (20) will transmit to the server (30) the commercial film in a suitable format together with the information of the subscribers (A) on whose smart devices (60) the advertiser (10) requires this commercial film to be broadcasted. The server (30) will place the commercial film into the commercial films storage space (50), and share the information on the new commercial film with the media management module (62) on the smart devices (60) of the selected subscribers (A). When the media management module (62) starts running just before the other modules (63) that the subscriber (A) operates on his/her smart device (60) in his/her free time, the commercial film transmitted from the server (30) will be played on the media management module (62).

The subscriber (A) would watch the commercial films of the brands marked as the brands whose commercials he/she would like to watch on his/her smart device (60) and/or according to the areas of interests he/she reported in the forms when the media management module (62) had operated for the first time, in a daily number determined by the mobile communication service provider (20) (for instance 10 commercial films daily of 30 seconds length at once), by means of operation of the media management module (62) just before the other modules (63) again reported by himself/herself as he/she runs in his/her free time.

When required the media management module (62) will be able to determine whether the subscriber (A) has watched the commercial film or not via the face recognition system on smart devices (60) with front cameras (61), and transmit this information to the potential customer database (40). If the mobile communication service provider (20) has determined the daily number of commercial films required to be watched as 10 films and the subscriber (A) has watched less than 10 commercial films on all of his/her associated smart devices (60) in a day, the media management module (62) would add the remaining commercial films to the next day's commercial films quota one by one for each operation.

When the system (1) is put into practice the mobile communication service provider (20) that is transformed into a media outlet/media organ broadcasting commercial films, will increase the per subscriber profitability by means of its off-site income and thus provide tariff discounts, financial advantages, and advantageous situations in direct proportion to the number of commercial films watched daily for its subscribers (A) who use the media management module (62).

A media management method (1000) transforming the mobile communication service providers (20) into media outlets/audio-visual media organs broadcasting commercial films for all marketable products, in all of the smart devices (60) of their subscribers (A) that have internet connection and audio-visual broadcasting abilities, and associating these smart devices (60) with each other, comprising the steps of:
Entering the identity and demographic information (21) held by the mobile communication service provider (20) of existing subscribers (A) into the potential customer database (40) operating on the server (30) (1001),
Operating the media management module (62) in the smart devices (60) of subscribers (A) (1002),
The subscribers (A) saving their subscriber shopping habits information (70) and customized settings information (80) into the media management module (62) (1003),
Transmission of the received subscriber shopping habits information (70) and customized settings information (80) to the server (30) via the media management module (62) in order to be entered into the potential customer database (40) (1004),
The server (30) processing the potential customer database (40) with the previously existing information (21) and the newly entered information (70, 80) and transmitting the reports to the mobile communication service provider (20) (1005),
The mobile communication service provider (20) transmitting these reports to the advertiser (10) exactly as they are or after filtering them (1006),
The advertiser (10) analyzing the reports provided by the mobile communication service provider (20) and transmitting to the mobile communication service provider (20) a commercial film in a suitable format together with the information of subscribers (A) on whose smart devices (60) the advertiser requires this commercial film to be broadcasted (1007),
The mobile communication service provider (20) transmitting to the server (30) the commercial film in a suitable format together with the information of subscribers (A) on whose smart devices (60) the advertiser (10) requires this commercial film to be broadcasted (1008),
The server (30) placing the commercial film into the commercial films storage space (50), and sharing the information on the new commercial film with the media management module (62) on the smart devices (60) of the selected subscribers (A) (1009),
The media management module (62) operating just before the other modules (63) that the subscriber (A) operates on his/her smart device (60) in his/her free time, and playing the commercial film transmitted from the server (30) (1010),
The media management module (62) determining whether the subscriber (A) has watched the commercial film or not via the face recognition system on smart devices (60) with front cameras (61) (1011), and
The media management module (62) reporting whether the subscriber (A) has watched the commercial film or not, to the potential customer database (40) on the server (30) (1012).

Based on these fundamental concepts, it is possible to develop various applications of a media management system (1) and a method (1000) transforming mobile communication service providers into media outlets/audio-visual media organs broadcasting commercial films for all marketable products in all of the smart devices of their subscribers, with have internet connection and audio-visual broadcasting abilities, and associating these smart devices with each other. The invention cannot be limited to the examples described herein and is as defined in claims.

1. A method (1000) about a media management system (1) transforming mobile communication service providers (20) into media outlets/audio-visual media organs broadcasting commercial films for all marketable products in all of the smart devices (60) of their subscribers (A) that have internet connection and audio-visual broadcasting abilities, and associating these smart devices (60) with each other, and it is characterized in comprising the operation steps of:
Entering the identity and demographic information (21) of existing subscribers (A) that are already held by the mobile communication service provider (20) into a potential customer database (40) operating on a server (30) (1001),
Operating the media management module (62) in the smart devices (60) of subscribers (A) (1002),
The subscribers (A) saving their subscriber shopping habits information (70) and customized settings information (80) into the media management module (62) (1003),
Transmission of the received subscriber shopping habits information (70) and customized settings information (80) to the server (30) via the media management module (62) in order to be entered into the potential customer database (40) (1004),
The server (30) processing the potential customer database (40) with the previously existing information (21) and the newly entered information (70, 80) and transmitting the reports to the mobile communication service provider (20) (1005),
The mobile communication service provider (20) transmitting these reports to the advertiser (10) exactly as they are or after filtering them (1006),
The advertiser (10) analyzing the reports provided by the mobile communication service provider (20) and transmitting to the mobile communication service provider (20) a commercial film in a suitable format together with the information of subscribers (A) on whose smart devices (60) the advertiser requires this commercial film to be broadcasted (1007),
The mobile communication service provider (20) transmitting to the server (30) the commercial film in a suitable format together with the information of subscribers (A) on whose smart devices (60) the advertiser (10) requires this commercial film to be broadcasted (1008),
The server (30) placing the commercial film into the commercial films storage space (50), and sharing the information on the new commercial film with the media management module (62) on the smart devices (60) of the selected subscribers (A) (1009),
The media management module (62) operating just the other modules (63) that the subscriber (A) operates on his/her smart device (60) in his/her free time;
and playing the commercial film transmitted from the server (30) (1010),
The media management module (62) determining whether the subscriber (A) has watched the commercial film or not via the face recognition system on smart devices (60) with front cameras (61) (1011), and
The media management module (62) reporting whether the subscriber (A) has watched the commercial film or not, to the potential customer database (40) on the server (30) (1012).

2. Method according to claim 1, characterized in that; in the step (1003) of the subscribers (A) saving their subscriber shopping habits information (70) and customized settings information (80) into the media management module (62), said customized setting (80) is the determination of before which other modules (63) the media management module (62) will operate in the smart devices (60).

3. Method according to claim 1, characterized in that; in the step (1003) of the subscribers (A) saving their subscriber shopping habits information (70) and customized settings information (80) into the media management module (62), said customized setting (80) is the determination of which smart devices (60) the media management module (62) will be associated with.

4. Method according to claim 1, characterized in that; in the step (1003) of the subscribers (A) saving their subscriber shopping habits information (70) and customized settings information (80) into the media management module (62), said customized setting (80) is the determination of the frequency of updating the information (70, 80) that the media management module (62) will obtain from the subscriber (A).

5. Method according to claim 1, characterized in that; in the step (1003) of the subscribers (A) saving their subscriber shopping habits information (70) and customized settings information (80) into the media management module (62), said customized setting (80) is the determination of the synchronization of the media management module (62) with web browsers and search engines.

6. Method according to claim 1, characterized in that; in the step (1003) of the subscribers (A) saving their subscriber shopping habits information (70) and customized settings information (80) into the media management module (62), said subscriber shopping habits information (70) is the information concerning the areas of interest of the subscribers (A).

7. Method according to claim 1, characterized in that; in the step (1003) of the subscribers (A) saving their subscriber shopping habits information (70) and customized settings information (80) into the media management module (62), said subscriber shopping habits information (70) is the information concerning the websites on which the subscribers (A) search for and/or from which subscribers (A) purchase products.

8. The method according to claim 1, characterized in that; in the step (1003) of the subscribers (A) saving their subscriber shopping habits information (70) and customized settings information (80) into the media management module (62), said subscriber shopping habits information (70) is the information concerning sectors and/or products, brands whose commercial films the subscribers (A) would like to watch.

9. A system (1) characterized in that; it transforms mobile communication service providers (20) into media outlets/audio-visual media organs broadcasting commercial films for all marketable products in all of the smart devices (60) of their subscribers (A) that have internet connection and audio-visual broadcasting abilities, and associates these smart devices (60) with each other, comprising:
At least one advertiser (10) transmitting to the mobile communication service provider (20) the commercial films and the information of the subscribers (A) on whose smart devices (60) these commercial films are required to be broadcasted,
At least one mobile communication service provider (20) which provides mobile internet service, shares the demographic information (21) with the potential customer database (40) on the server (30), transmits the commercial films to the server (30) to be loaded into the commercial films storage space (50), transmits to the server (30) the information of the subscribers (A) on whose smart devices (60) the advertiser (10) requires the commercial films to be broadcasted, and presents the reports it has received from the potential customer database (40) to the advertiser (10) exactly as they are or after filtering them,
At least one subscriber demographic information (21) representing the information such as identity and gender, race, age, employment state, level of income, occupation, residence etc. of the subscribers (A) of the mobile communication service provider (20),
At least one subscriber shopping habits information (70) which the subscribers (A) enter into the media management module (62), concerning their areas of interests, shopping habits, the websites on which they search for products and/or the websites from which they purchase products, and the products/brands whose commercials they would like to watch on the media management module (62) etc.,
At least one customized setting information (80) concerning:
before which other modules (63) installed on their smart devices (60), the subscribers (A) would like the media management module (62) to operate,
which of their smart devices (60) they choose to associate with the media management module (62),
the frequency of updating the information (70, 80) that the media management module (62) will obtain from the subscriber (A),
the information about the synchronization of the media management module (62) with the search engines and web browsers,
At least one server (30) processing and updating the potential customer database (40) with the information transmitted from the media management module (62) and the mobile communication service provider (20), reporting to the mobile communication service provider (20), loading the commercial films transmitted from the mobile communication service provider (20) into the commercial films storage space (50), and transmitting the commercial films from the commercial film storage space (50) to the media management module (62) on the smart device (60) of the subscriber (A) selected from the potential customer database (40) in accordance with the preferences of the advertiser (10) which are received from the mobile communication service provider (20),
At least one potential customer database (40) that gathers the subscriber demographic information (21) provided by the mobile communication service provider (20) and the subscriber shopping habits information (70) and customized settings information (80) provided by the media management module (62),
At least one commercial films storage space (50) that stores the commercial films transmitted from the mobile communication service provider (20),
At least one smart device (60) that operates the media management module (62) and the other modules (63), and has internet connection and audio-visual film broadcasting abilities,
At least one front camera (61) which exists on the front side of smart devices (60) and is used for determining the interest of subscribers (A) concerning the commercials,
At least one media management module (62) which:
operates and plays the commercial films transmitted from the server (30) just before the operation of the other modules (63) that the subscribers (A) would like to operate,
transmits to the potential customer database (40), the information (70, 80) obtained from the subscribers (A),
associates all of the available smart devices (60) indicated by the subscribers (A) with each other, and thus enables the subscribers to meet their daily commercial film quota, determined by the mobile communication service provider (20), by watching the required commercial films on various smart devices (60),
and is able to determine whether subscribers (A) watch commercial films entirely or not, by operating the front camera (61) when the films start to play,
At least one other module (63), installed on the smart device (60), which is independent from the media management module (62) and before which the media management module (62) operates.
